(19) United States
(12) Patent Application Publication
(10) Pub. No.: US 2006/0126836 A1
(43) Pub. Date: Jun. 15, 2006

(54) System and method for dynamic generation of encryption keys

(76) Inventor: Hector Rivas, Covington, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/008,824

(22) Filed: Dec. 10, 2004

(51) Int. Cl. H04L 9/00

(52) U.S. Cl. 380/47

(57) ABSTRACT

In accordance with an aspect of the present invention, a method for dynamically encrypting and decrypting digital information using a dynamically generated keys is provided. The method includes, obtaining digital information to be encrypted and identifying a file that is to be used in generating a dynamic key. The identified file is used in conjunction with a key generation algorithm to generate a dynamic key and that dynamic key is used with an encryption algorithm to encrypted the digital information. Likewise, to decrypt the encrypted digital information, a file is identified that is to be used to generate a dynamic key. That file and a key generation algorithm are used to generated a dynamic key. The dynamic key is used in conjunction with a decryption algorithm to decrypt the digital information.

### FIELD OF THE INVENTION

In general, the present invention relates to computer software, and in particular, to a system and method for dynamically generating encryption keys.

### BACKGROUND OF THE INVENTION

With the development of computer technology, computer networking, and the Internet, the transfer of digital information has rapidly increased. Additionally, with the increase in the transfer of digital information, there has been an increase in unauthorized parties (i.e., eavesdroppers) intercepting and interpreting transmitted digital information that is not intended for them. Thus, techniques, such as encryption, have been developed to secure the information so that only the intended parties are able to understand the substance of the message. The concept behind encryption is quite simple—make the digital information illegible for everyone except the intended parties.

Two existing techniques for encrypting digital information is symmetric (private key) encryption and asymmetric (public key) encryption. Private key encryption, also referred to as conventional or single-key encryption, has five major parts: plaintext, a symmetric encryption algorithm, a secret key, ciphertext, and a symmetric decryption algorithm. “Plaintext,” as used herein, is the digital information, or message, that is to be encrypted. A “symmetric encryption algorithm,” as used herein, is an algorithm that performs mathematical operations to conduct substitutions and transformations to the plaintext. A “secret key,” as used herein, is the input for the encryption algorithm that dictates the encrypted outcome. “Ciphertext,” as used herein, is the encrypted digital information produced by applying the symmetric encryption algorithm to the plaintext message using the secret key. The “symmetric decryption algorithm,” as used herein, is the symmetric encryption algorithm in reverse. It uses the ciphertext, and the secret key to derive the plaintext message.

When using private key encryption, the sender and the receiver must have the same secret key. However, if unintended parties obtain the secret key, they may also be able to decrypt the message. Thus, it is essential that the sender and the receiver both know the secret key, have a secure way to exchange the secret key, and keep the secret key secret.

Even though rightful holders of a secret key may be diligent in attempting to keep the key secret, the secret key may nonetheless be determined by eavesdroppers. For example, a secret key may be obtained by an eavesdropper discovering it from a party who rightfully has the key. Another technique is by using all possible combinations of algorithms and keys on an encrypted message to determine the plaintext. Additionally, a secret key may be obtained by attacking the characteristics of the algorithm being used to deduce the secret key that was used. Once the secret key and algorithm have been determined, all past and future communications may be discerned.

While discovery of private keys may prove difficult, management of secret keys is a severe drawback. For example, each combination of parties must have their own secret key. Thus, if an individual wants to send secure messages to several different parties, the individual must maintain a secret key for each individual. The larger the group, the more daunting the problem, especially for administrators. For example, a one-hundred-user network requires 4,950 separate keys. Still further, because a key may be compromised (i.e., discovered by an eavesdropper) at any time, the secret keys need to be changed periodically. The total number of symmetric keys necessary for a group of users may be calculating using the following arithmetic sequence formula:

$$S = \frac{( {n}^{2} - n )}{2}$$

Where S is the number of keys that are needed and n is the total number of users.

Public key encryption schemes make key management much easier because different keys are used to encrypt and decrypt the ciphertext. The basis behind public key encryption is the one-way mathematical difficulty in factoring numbers. For example, while it is simple to multiply primes to generate a product, it is difficult and time consuming to take the product and reduce it back to its original primes. For big prime numbers (over one-hundred digits long) it is time-consuming, even for fast computers, to determine the primes.

Public key encryption schemes have six major parts: plaintext, a public encryption algorithm, public and private keys, ciphertext, and a public decryption algorithm. A “public encryption algorithm,” as used herein, performs mathematical operations to conduct substitutions and transformations to the plaintext. The “public decryption algorithm,” as used herein, uses the ciphertext and the matching private key to produce the plaintext.

Public key encryption schemes, such as the Rivest-Shamir-Adleman (RSA) encryption scheme, use the product of two large prime numbers as the public key and the two prime numbers themselves as the private key. The public key is made available, typically via email or public Internet posting, by a receiving party. The matching private key is kept secret by the receiving party. The public key is obtained by a sending party and used, along with a public encryption algorithm, to encrypt the plaintext into ciphertext. The private key is used by the receiving party, along with a public decryption algorithm, to decrypt the ciphertext to obtain the plaintext.

While public key encryption simplifies the management of keys, it is rarely used to encrypt message due to the computation required. As a result, public key encryption schemes are more often used in an effort to solve the key management problem of private key encryption schemes. Public key encryption is often employed to distribute symmetric keys, which are then used to encrypt and decrypt messages using private key encryption. Another drawback to public key encryption is that the sending party must first obtain the receiving parties public key and further, must rely on the security of the receiving parties private key. As discussed above, a message is encrypted using the receiving parties public key so that it may be decrypted by the receiving party using their private key. If the receiving parties private key has been compromised, the message will not be secure.

Additionally, even though public key encryption may be used to transmit private keys, those private keys may still be obtained using the techniques discussed above. Thus, there is a need for a system and method for dynamically generating keys (encryption and decryption) so that encryption/decryption keys do not need to be transmitted and/or stored by either party.

### SUMMARY OF THE INVENTION

Embodiments of the present invention provide the ability to encrypt digital information without having to store and/or transmit an encryption/decryption key. Still further, embodiments of the present invention provide the ability to send secure messages without having to rely on the security of the receiving party's key. While embodiments of the present invention will be described with respect to the secure transmission of a digital message between two parties, it will be understood that the invention is equally applicable to any type of digital information that needs to be secured. For example, any type of digital file, database, message, etc., may be encrypted to maintain its security utilizing embodiments of the present invention. Additionally, embodiments of the present invention work within any type of environment, including but not limited to, peer to peer networks, a client-host network, a peerless environment (e.g., the Internet), etc.

In accordance with an aspect of the present invention, a method for dynamically encrypting digital information is provided. The method includes, obtaining digital information to be encrypted and identifying a file that is to be used in generating a dynamic key. The identified file is used in conjunction with a key generation algorithm to generate a dynamic key and that dynamic key is used with an encryption algorithm to encrypted the digital information.

In accordance with another aspect of the present invention, a method for updating a dynamic encryption key generation system is provided. The method includes identifying a client for which an update is to be performed and upon client identification, determining whether a file library is to be updated. A file library, as described herein, includes at least one file that may be used to generating a dynamic key. In response to determining that the file library is to be updated, the method provides an update to the file library.

In accordance with another aspect of the present invention, a dynamic key generation system is provided. The dynamic key generation system includes a library, including a file that may be used for computing a dynamic key and at least one dynamic key generation algorithm for use in conjunction with the file for computing a dynamic key.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a system that is capable of transmitting secure messages between a client and a host, in accordance with an embodiment of the present invention;

FIG. 2 is a block diagram illustrative of another secure computing environment, in accordance with an embodiment of the present invention;

FIG. 3 is a block diagram illustrating a secure communication system for securely transmitting messages between a host and a client, in accordance with an embodiment of the present invention;

FIG. 4 is a flow diagram illustrative of an encryption routine for encrypting digital information, in accordance with an embodiment of the present invention;

FIG. 5 is a flow diagram illustrative of the secure client subroutine, in accordance with an embodiment of the present invention;

FIG. 6 is a flow diagram illustrative of a key generation update routine, in accordance with an embodiment of the present invention; and

FIG. 7 is a flow diagram illustrative of a decryption routine for decrypting an encrypted message, in accordance with an embodiment of the present invention.

### DETAILED DESCRIPTION OF THE PREFERRED EMBODIMENT

Embodiments of the present invention provide the ability to encrypt digital information without having to store and/or transmit an encryption/decryption key. Still further, embodiments of the present invention provide the ability to send secure messages without having to rely on the security of the receiving party's private key. As described below, a secure computing environment is established between at least two parties by one party (referred to herein as the “host”) providing another party (referred to herein as a “client”) with information that may be used to dynamically generate encryption keys and decryption keys (referred to herein as a “dynamic key”) each time digital information is to be encrypted. A dynamic key is used along with an encryption algorithm (public or private) to encrypt the plaintext message into ciphertext. Likewise, a dynamic key is used along with a decryption algorithm to decrypted a ciphertext message into plaintext. Messages may be encrypted and transmitted and received and decrypted by either a host or a client.

Embodiments of the present invention utilize a digital file (e.g., a JPEG file) and a key generation algorithm to generate the dynamic key. The key generation algorithm may be a publicly available algorithm, a private algorithm, or selected from several algorithms that are provided by the host. Additionally, the key generation algorithm(s) provided by a host may also be updated frequently to increase security. Still further, the files used in conjunction with the key generation algorithm may be selected from a plurality of files stored in a library on the encrypting/decrypting computer. Those files may also be updated and changed to increase security. Likewise, the files may be publically available, private files, or files provided by the host. The only constraint to the security system is that at least one of the key generation algorithm or the file used in conjunction with the algorithm be secret between the client and the host.

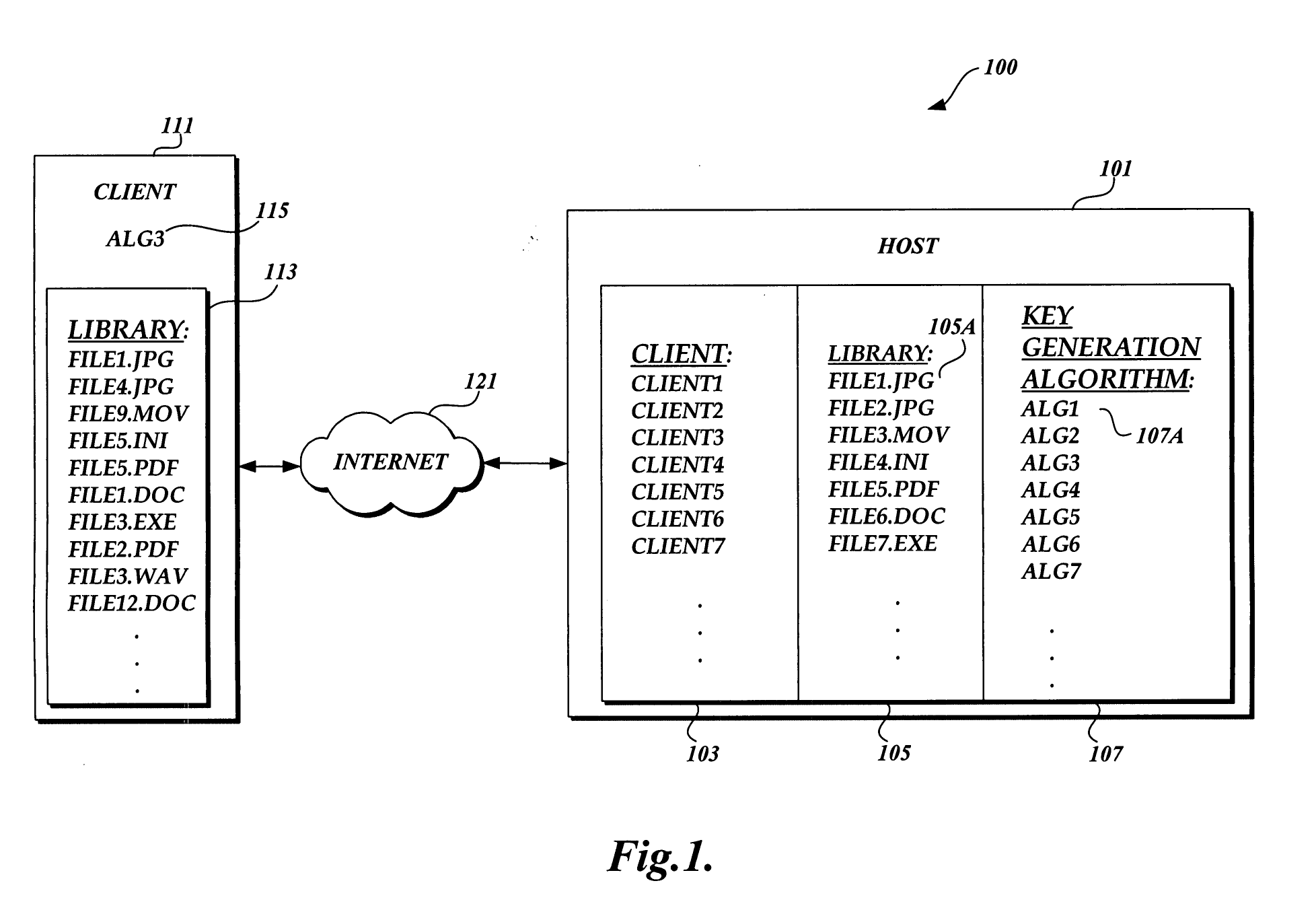

FIG. 1 is a block diagram illustrative of a system that is capable of transmitting secure messages between a client and a host, in accordance with an embodiment of the present invention. As shown in FIG. 1, a host 101 maintains a list of clients 103 for which it may transmit and receive secure messages. Additionally, the host 101 maintains a library 105 containing files, such as FILE1.JPG 105A. Some or all of those files are provided to clients of the host 101 for use in generating a dynamic key. Additionally, the host 101 includes a list of key generation algorithms 107. The key generation algorithms, such as ALG1 107A, are used in conjunction with one of the files from the library 105 to generate a dynamic key that is used with an encryption algorithm to encrypt a plaintext message. One or more of the key generation algorithms are provided to clients of the host 101.

As will be described in more detail below, the host 101 provides a client, such as client 111, with a library of files, such as client library 113, that includes one or more files that may be used in generating a dynamic key. The files of the client library 113 may be any type of file, such as a JPEG file, movie file, .INI file, .PDF file, Word document, Excel document, audio file, video file, etc. Any one of, or several of, the files may be used in generating a dynamic key. Additionally, an entire file or a portion of a file may be used in generating a dynamic key.

The host 101 may update any of the files contained in a client library 113 or alternatively update and replace the entire client library 113 that is stored on a client 111. The host 101 also provides the client 111 with one or more key generation algorithms, such as ALG3 115 that is used in conjunction with one of the client library 113 files to generate a dynamic key. Communication between a host 101 and a client 111 may be accomplished through any type of communication medium, such as the Internet 121. Additionally, the communication between a client 111 and a host 101 may be wired or wireless.

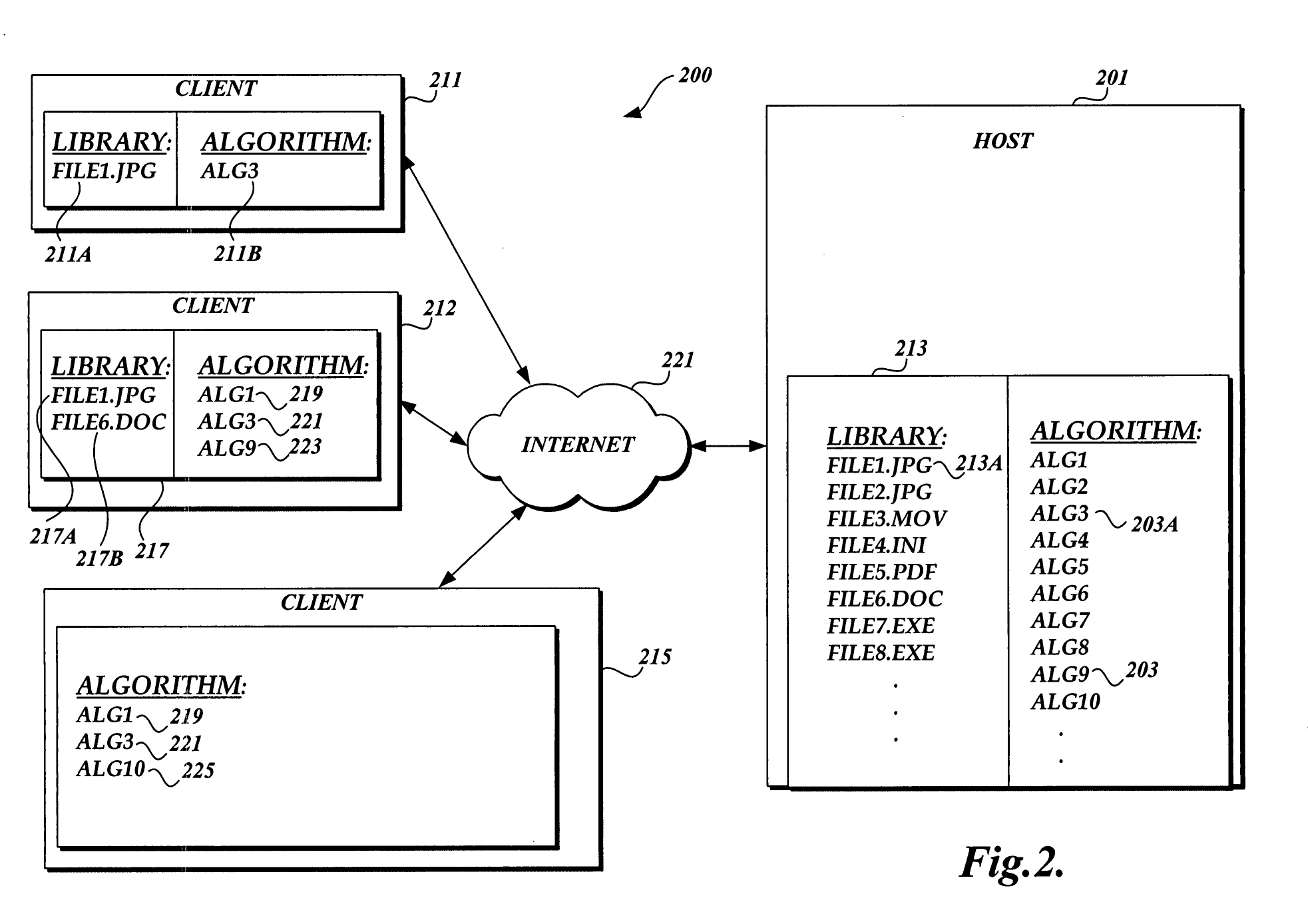

FIG. 2 is a block diagram illustrative of another secure computing environment, in accordance with an embodiment of the present invention. In particular, a secure computing environment 200 includes a host 201 and three clients, 211, 212, 215. The secure environment 200 may be established between a host 201 and the clients in a number of fashions. For example, the secure environment 200 between the host 201 and a client, such as client 211, may be accomplished by providing the client 211 with a library containing one file, FILE1.JPG 211A, and one key generation algorithm, ALG3 211B. Alternatively, the library may contain several files and/or there may be several algorithms.

As will be described in more detail below, to transmit an encrypted message from the client 211 to the host 201, in accordance with an embodiment of the present invention, the key generation algorithm ALG3 211B is used in conjunction with FILE1.JPG 211A to generate a dynamic key that is used with an encryption algorithm to encrypt a plaintext message into ciphertext.

The host 201 may also transmit encrypted messages to the client 211 in a similar manner. In particular, the host 201 identifies the client 211, and using FILE1.JPG 213A and key generation algorithm 203A, copies of which were previously provided to the client 211, computes a dynamic key. The dynamic key is used in conjunction with an encryption algorithm, such as a symmetric encryption algorithm, to encrypt the message containing the sensitive data into ciphertext. Once that message has been encrypted, the host 201 transmits the message via a communication network, such as the Internet 221, to the client 211. The client 211, upon receiving an encrypted message from the host 201, uses the previously provided algorithm, ALG3 211B, and FILE1.JPG 211A, to generate a dynamic key. The dynamic key is used in conjunction with a decryption algorithm, such as a symmetric decryption algorithm, to decrypt the ciphertext, to ascertain the message containing the sensitive data (plaintext) that was transmitted to the client 211 from the host 201.

In another embodiment, a secure computing environment 200 may be established between the host 201 and a client, such as client 212, by providing the client 212 with a library containing a plurality of files that may be used within a dynamic key generation algorithm to generate a dynamic key. In particular, the host 201 may provide the client 212 with a library 217 containing a plurality of files such as FILE1.JPG 217A and FILE6.DOC 217B. The library 217 may contain any number and combination of types of files that may be used in computing a dynamic key. Still further, the host 201 may provide the client 212 with one or more key generation algorithms, such as ALG1 219, ALG3 221, and ALG9 223. It will be appreciated that any number of key generation algorithms may be provided from a host to a client for use in conjunction with any one of the files of a library in generating a dynamic key.

Continuing with the example of the secure computing environment 200 established between the host 201 and the client 212, if the host 201 desires to transmit a secure message to the client 212, it first identifies the client and selects one of the files from the host library 213 that it has previously provided to the client 212 in the client library 217. For example, the host 201 may select FILE1.JPG 213A that is contained within the host library 213 and which is also contained in the client library 217. Additionally, the host 201 selects a key generation algorithm from its list of key generation algorithms that it has also previously provided to the client 212. For example, the host 201 may select ALG9 203 for use in computing a dynamic key. Using the algorithm, ALG9 203, and the selected file, FILE1.JPG 213A, the host generates a dynamic key for use with an encryption algorithm, such as a symmetric encryption algorithm, to encrypt into ciphertext the plaintext message that it desires to send to the client 212.

Upon encryption of the message into ciphertext, the host 201 appends a file path identification for the file that it used to generate the dynamic key. Upon appending the file path identification to the encrypted message that file path identification may also be encrypted using any type of encryption technique, such as public key encryption, as discussed above. Still further, the entire message, including the encrypted message and the other identification may additionally be further encrypted using any encryption key scheme, such as public key encryption. The encrypted message is transmitted from the host 201 to the client 212 via the Internet 221, or other type of network.

Upon receipt by the client 212 of an encrypted message from the host 201, the client ascertains the file path identification contained within the encrypted message and identifies the corresponding file 217A from the library 217 stored on the client 212. Additionally, if the client 212 has been provided with more than one key generation algorithm, the client 212 selects one of the key generation algorithms, and using the selected key generation algorithm in conjunction with the identified FILE1.JPG 217A, generates a dynamic key. The dynamic key is used with a decryption algorithm, such as a symmetric decryption algorithm, to decrypt the ciphertext message. Upon decrypting the message, if it is determined that the plaintext of the encrypted message is not understandable, the client 212 selects the next key generation algorithm, such as ALG3 221 and computes a new decryption key. This process continues until the appropriate key generation algorithm is identified and the plaintext of the encrypted message is intelligible.

As an alternative to proceeding through each of the encryption algorithms maintained by the client 212, the encrypted message sent by the host 201 may also include an algorithm identifier to indicate to the client 212 which algorithm to use in generating the dynamic key. In yet another example, the client 212 may previously know which algorithm to use. For example, one algorithm may always be used, the algorithms may be cycled through sequentially selecting the next one for each computation, etc.

In yet another embodiment, a secure computing environment 200 may be established between a host 201 and a client 215. During establishment of the secure computing environment 200, the host 201 provides the client 215 with one or more key generation algorithms, such as ALG1 219, ALG3 221, and ALG10 225. Additionally, the host 201 identifies one or more files that are currently stored on the client computing device 215 that it will use along with one of the algorithms to generate a dynamic key. A copy of the identified file is obtained from the client 215 and maintained at the host 201.

In this embodiment, if the host 201 desires to send a secure message to the client 215, the host 201 identifies one of the key generation algorithms that it has previously provided to the client 215 and using the copy of the obtained file, computes a dynamic key. The dynamic key is used in conjunction with an encryption algorithm, such as a symmetrical encryption algorithm, to encrypt the information that is to be securely transmitted to the client 215. In addition to encrypting the message, the host 201 appends a file path identifier, identifying the location of the file used to generate the encryption key, to the encrypted message. Alternatively, the client may already be aware of what file is to be used in generating the key and as such, a file path identifier need not be appended to the message.

The encrypted message is transmitted from the host 201 to the client 215 via a communication network, such as the Internet 221. The client 215, upon receipt of an encrypted message from the host 201, identifies the appropriate key generation algorithm, as discussed above, and locates the file using the file path identifier contained within the received encrypted message (or of which it is previously aware). Using the appropriate key generation algorithm and the file stored on the client 215, the client generates a dynamic key that is used with a decryption algorithm to decrypt the received ciphertext message.

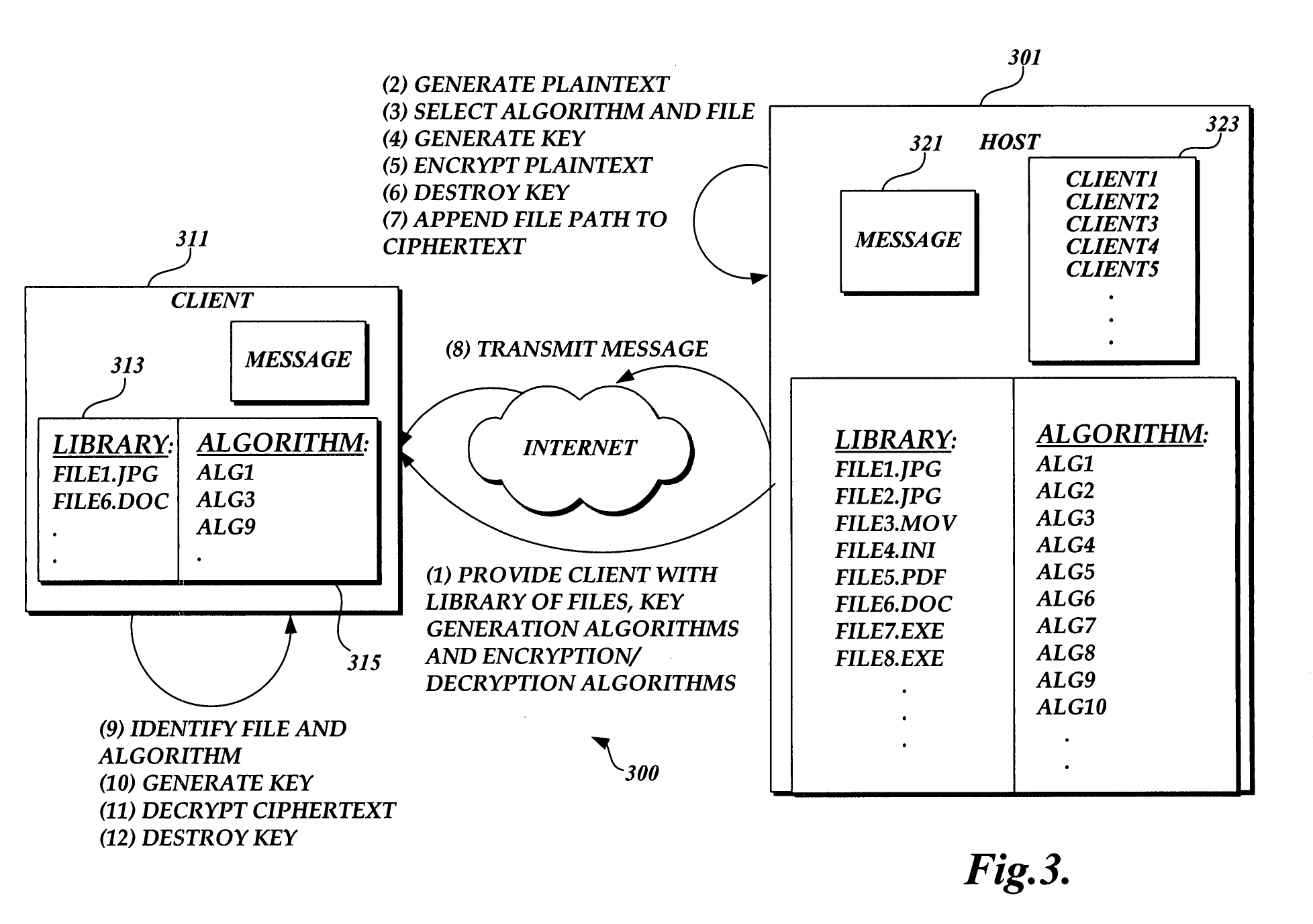

FIG. 3 is a block diagram illustrating a secure communication system for securely transmitting messages between a host and a client, in accordance with an embodiment of the present invention. To establish a secure computing environment 300 between a host 301 and a client 311, the host 301 first provides the client 311 with a library of files, key generation algorithms, and encryption/decryption algorithms. As discussed above, the library may contain one or more electronic files that are used in conjunction with a key generation algorithm to generate dynamic keys. Likewise, the host may provide one or more key generation algorithms. The key generation algorithms may be publicly available or known only to the host and the client. Still further, the encryption/decryption algorithms may be any type of encryption/decryption algorithms that are used with encryption/decryption keys to encrypt and decrypt messages that are transmitted between host 301 and the client 311.

For example, the host 301 may provide the client 311 with a library 313 containing a plurality of files. Additionally, the host 301 may provide the client 311 with a list of key generation algorithms 315. Finally, the host 301 may provide the client 311 with symmetric encryption/decryption algorithms (not shown). The library of files 313, key generation algorithms 315, and encryption/decryption algorithms may be provided to the client 311 in a variety of fashions. For example, the information may be provided via a recordable medium, such as a compact disc, floppy disk, or other type of portable memory. Alternatively, the information may be provided from the host 301 to the client 311 using a public key encryption scheme or private key encryption scheme, as discussed above.

Because the information used to encrypt and decrypt messages may be selected from a plurality of different items, such as files and key generation algorithms, it increases the difficulty in compromising the encryption scheme. By providing clients with several files and key generation algorithms, the same information (library, key generation algorithms, encryption/decryption algorithms) may be provided to all clients yet each client may be assigned a unique combination of key generation algorithms and files, thereby resulting in unique dynamic keys for each client. Still further, the files and algorithms used for a particular client may be easily changed (thereby changing the dynamic key) without the need to provide the client with additional information.

Once the security information has been provided to the client 311, the host 301 or client 311 may encrypt a plaintext message 321 into ciphertext and it may be securely transmitted between those parties over any type of communication medium, such as the Internet. Once the host 301 has generated a plaintext message 321 and identified the client to whom the plaintext message 321 is to be transmitted, it may determine the files/key generation algorithms that have been provided to that client. Continuing with the current example, the host 301 identifies the client 311 and utilizing a client identification file 323 ascertains that the client 311 has been provided with several files, including FILE1.JPG, and provided with several key generation algorithms, including ALG9. Using FILG1.JPG and ALG9, the host 301 generates a dynamic key that is to be used to encrypt the plaintext message.

Using the dynamic key, the host 301 encrypts the plaintext message 321 using any type of encryption scheme to generate the ciphertext. Once the dynamic key has been used to encrypt the plaintext message 321, the host 301 destroys the dynamic key and appends a file path identifier to the ciphertext. The file path identifier that is appended to the ciphertext identifies a location on the client 301 of the file that was used to generate the encryption key. Once the file path identifier has been appended to the ciphertext, the encrypted message is transmitted via a communication medium, such as the Internet, to the client 311.

A client 311, upon receipt of an encrypted message, identifies the location of the file that was used to create the dynamic key to encrypt the message by ascertaining the file path identifier included in the encrypted message. Additionally, the client 311 selects a key generation algorithm contained with the security information that was previously provided. As discussed above, if the client has more than one key generation algorithm, it may utilize each algorithm until the appropriate dynamic key is generated. Alternatively, the encrypted message may include an algorithm identifier identifying what algorithm is to be used to generate the dynamic key or the client may have prior knowledge as to which algorithm to use.

Using the selected key generation algorithm and identified file, the client 311 generates a dynamic key that is used in conjunction with a decryption algorithm to decrypt the message. Upon decryption of the message, the client 311 destroys the dynamic key.

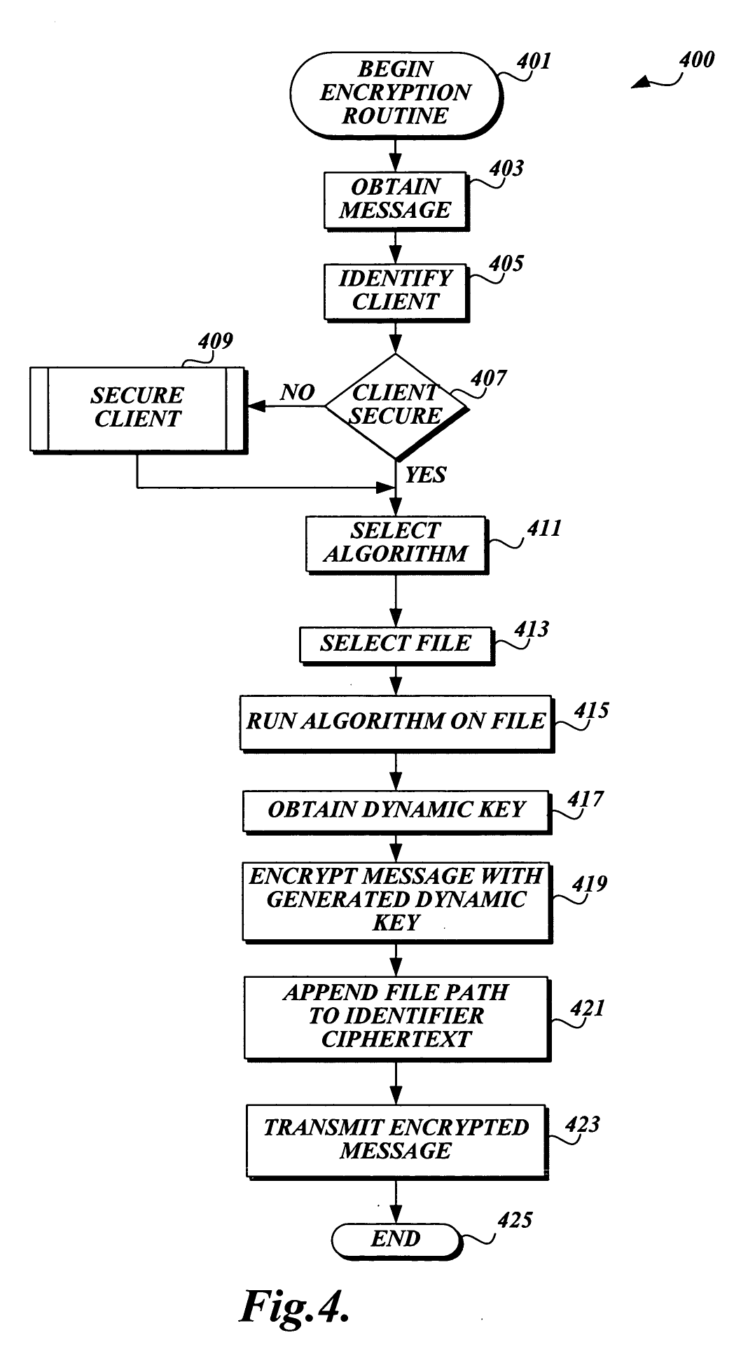

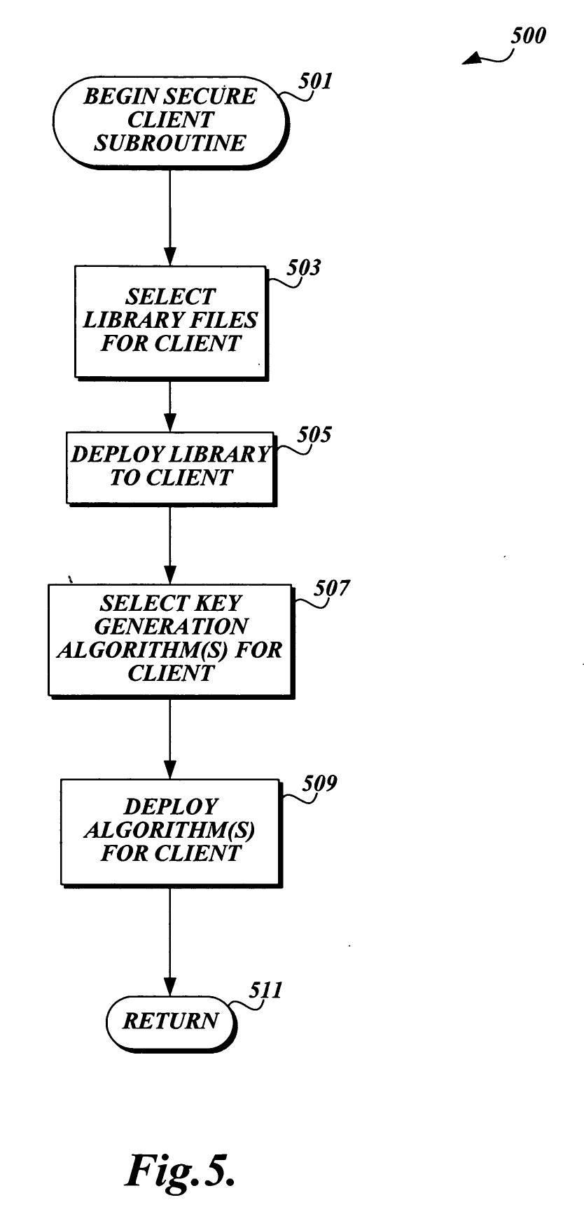

FIG. 4 is a flow diagram illustrative of an encryption routine for encrypting digital information, in accordance with an embodiment of the present invention. The encryption routine 400 begins at block 401 and at block 403, digital information, such as a plaintext message, that is to be encrypted is obtained. At block 405, the encryption routine 400 determines the client to which the digital information is to be sent. Upon identification of the client, at decision block 407, a determination is made as to whether the identified client is a secure client. A secure client, as discussed above, is a client that has received information necessary for encrypting and decrypting messages. If it is determined at decision block 407 that the identified client is not a secure client, at block 409 the secure client subroutine 500 (discussed with respect to FIG. 5) is performed to provide the identified client with the information necessary for making that client a secure client.

However, if it is determined at decision block 407 that the identified client is a secure client, or upon completion of the secure client subroutine 500, at block 411 a key generation algorithm is selected that will be used for generating a dynamic key.

At block 413, the encryption routine 400 identifies a file from a library of files that it will use in conjunction with the key generation algorithm for generating the dynamic key. The file is selected at block 413 by identifying what files of the library have previously been provided to the client identified at block 405. At block 415, the key generation algorithm is executed in conjunction with the selected file to generate a dynamic key. The dynamic key will be used in conjunction with an encryption algorithm to encrypt the plaintext. At block 417, the generated dynamic key is obtained and at block 419, the dynamic key is used in conjunction with an encryption algorithm to encrypt the digital information. Examples of encryption algorithms include, but are not limited to, symmetric encryption algorithms and asymmetric encryption algorithms. Once the digital information has been encrypted at block 419, at block 421, a file path identifier identifying the location of the file selected at block 413 on the client computer is appended to the ciphertext. At block 423, the encrypted message and the appended file path identifier are transmitted to the client and the encryption routine 400 completes at block 425.

FIG. 5 is a flow diagram illustrative of the secure client subroutine 500, in accordance with an embodiment of the present invention. As referenced above, the secure client subroutine 500 is used to provide a client with the information necessary for establishing secure communications between the host party and the client. The secure client subroutine begins at block 501 and at block 503 the host selects a library of files that are to be provided to the client. As discussed above, the library of files may contain one or more digital files that are capable of being used with a key generation algorithm for dynamically generating an encryption key. The files of the library may be any type of digital information files, such as, but not limited to, JPEG files, movie files, PDF files, Word documents, Excel files, audio files, video files, etc. Upon selection of a library of files, at block 505, the host deploys the selected library of files to the client. The library of files may be deployed to the client in any number of fashions. For example, the library of files may be stored on portable media, such as a floppy disk or CD-ROM, and given to the client. Alternatively, the library of files may be electronically transmitted to the client in an encrypted or unencrypted form.

In addition to providing a client with a library of files used for generating a dynamic key, at block 507, the subroutine 500 selects one or more key generation algorithms that are to be provided to the client and used in conjunction with one of the files from the library to generate a dynamic key. At block 509, the selected key generation algorithms are deployed to the client. As with the library of files, the key generation algorithms may be deployed to the client in a variety of forms including, but not limited to, providing them to the client on some form of portable media or electronically transmitting them to the client. The key generation algorithms may be provided to the client on the same or different items of media than the library of files provided at block 505. At block 511, the secure client subroutine 500 completes and returns control to the encryption routine 400 (FIG. 4).

Because embodiments of the present invention do not require the storage of keys on the host or its clients, and the keys are dynamically generated each time they are used, it is easy for a host to effectively modify the dynamically generated keys by altering the information used to generate those keys. For example, a host may use a different file in conjunction with an algorithm to generate an encryption key and/or add or replace files in the library. By changing the file used to generate the dynamic key, the dynamic key itself is effectively changed. In addition to, or as an alternative to, updating files of a library, a host may alter or modify the key generation algorithm that is used in conjunction with a file to generate the dynamic key. These two techniques, alone or in combination, provide the ability for a host to continually change the key that is used to secure its information thereby increasing the likelihood that the secured information will not be compromised.

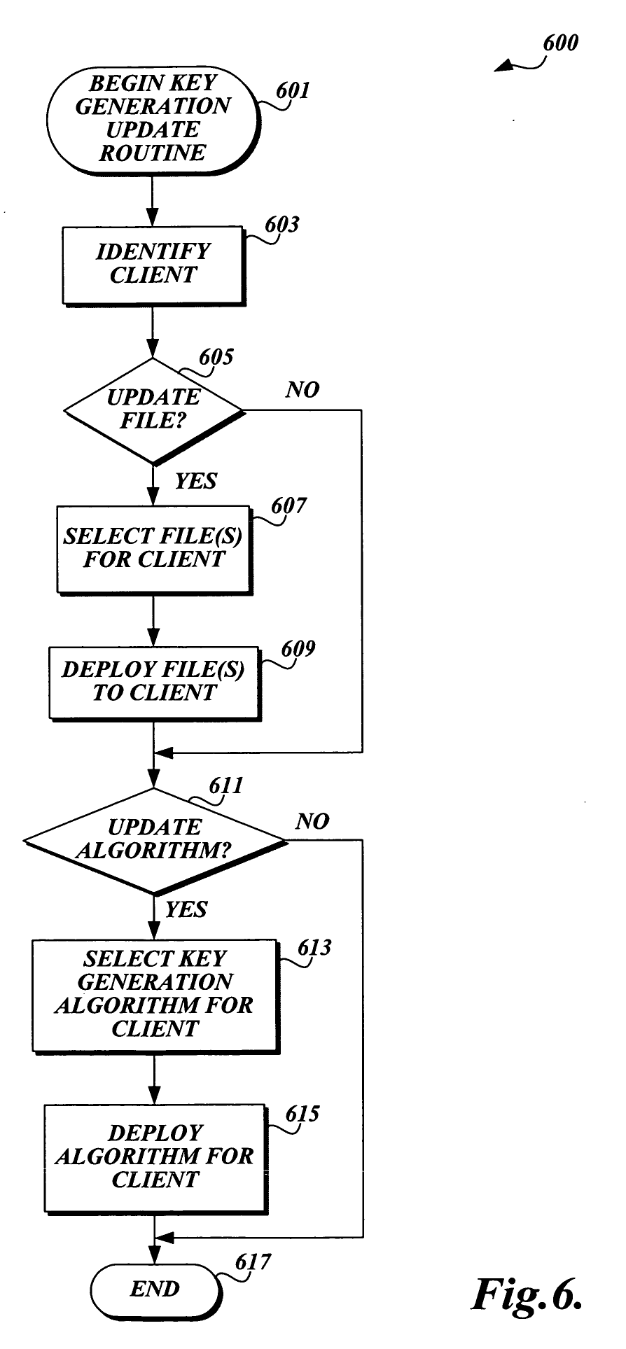

FIG. 6 is a flow diagram illustrative of a key generation update routine, in accordance with an embodiment of the present invention. The key generation update routine 600 begins at block 601 and at block 603 a client for which an update is to be performed is identified. Upon identification of a client, at decision block 605, it is determined whether one or more of the library files is to be updated. The library files may be updated by replacing existing files stored in a library and/or by adding new files to the library. If it is determined at decision block 605 that a file is to be updated, at block 607 the key generation update routine 600 selects one or more files that are to be added and/or used to replace files of the library that are currently stored on the identified client. Upon selection of new files, at block 609, the selected files are deployed to the client. New files may be deployed to a client using the encryption routine 400 (FIG. 4) to encrypt and transmit those files to the client. Alternatively, the selected files may be provided to the client on any type of physical media and loaded onto the client's computer.

Referring back to decision block 605, if it is determined that a library file is not to be updated, or after selective files have been deployed to the client at block 609, at decision block 611 a determination is made as to whether key encryption algorithms currently existing on the client are to be updated and/or replaced. If it is determined at decision block 611 that key generation algorithms currently existing at the client are to be updated and/or replaced, at block 613 the key generation update routine 600 selects key generation algorithms that are to be provided to the client. At block 615, the selected key generation algorithms are provided to the client. The key generation algorithms may be provided to the client by encrypting those algorithms using the encryption routine 400 (FIG. 4) and transmitting those algorithms to the client. Alternatively, the key generation algorithms may be deployed to the client on any type of physical media, such as floppy disk or CD. At block 617, the key generation update routine 600 completes.

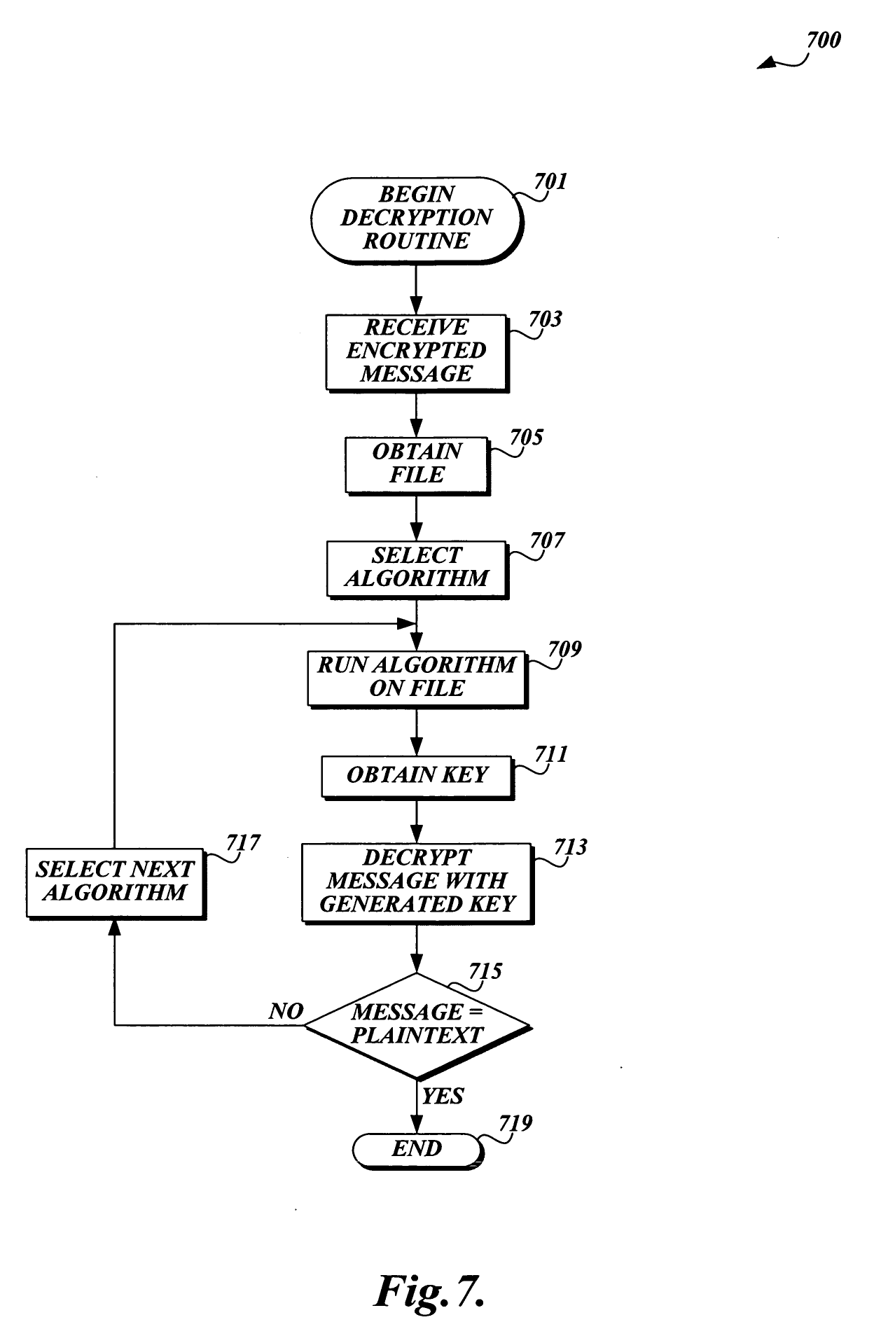

FIG. 7 is a flow diagram illustrative of a decryption routine for decrypting an encrypted message, in accordance with an embodiment of the present invention. The decryption routine 700 begins at block 701 and at block 703 an encrypted message is received. At block 705, a file that is to be used in generating a dynamic key for decrypting the message is obtained. The file may be obtained by identifying from within the received encrypted message a file path identifier identifying a location of the file. Alternatively, for embodiments where a party receiving an encrypted message has only been provided with one file that will be used to generate a dynamic key, that file is obtained. In yet another embodiment, the receiving party may already be aware of the file that is to be used.

At block 707, a key generation algorithm is selected that is to be used in conjunction with the file obtained at block 705 for generating a dynamic key. The dynamic key will be used to decrypt the encrypted message. As discussed above, a key generation algorithm may be selected by selecting the only key generation algorithm that was provided to the receiving client, by selecting a first of a list of algorithms, by identifying a key generation algorithm based on some type of algorithm identifier included in the received encrypted message, or the appropriate key generation algorithm may be known to the receiving party.

At block 709, upon selection of a key generation algorithm and a: file, the algorithm is executed in conjunction with the file to generate a dynamic key. The dynamic key is obtained, as illustrated by block 711, and at block 713 the dynamic key is used in conjunction with any type of decryption algorithm to decrypt the encrypted message.

At decision block 715, it is determined whether the decrypted message is an intelligible message. Decision block 715 is utilized for embodiments where the receiving party maintains a plurality of key generation algorithms that are sequentially selected to generate dynamic keys that are used to decrypt the message. If the wrong key generation algorithm is used in conjunction with the appropriate file, it will not produce the appropriate key for use in decrypting the message. Therefore, the message will be unintelligible. If it is determined at decision block 715 that the message is unintelligible, at block 717, the next algorithm in the plurality of algorithms maintained by the receiving party is selected and the routine 700 returns to block 709 and continues. However, if it is determined at decision block 715 that the decrypted message is intelligible, the routine completes at block 719.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for dynamically encrypting digital information, the method comprising:
obtaining digital information to be encrypted;
identifying a item of data;
executing a key generation algorithm in conjunction with the identified item of data to generate a dynamic key; and
encrypting the digital information using the dynamic key and an encryption algorithm.

2. The method of claim 1, wherein the key generation algorithm is selected from a plurality of key generation algorithms.

3. The method of claim 1, wherein the item of data is a file and the file is selected from a plurality of files.

4. The method of claim 1, further comprising:
appending a data path identifier to the encrypted digital information that identifies a location of the item of data.

5. The method of claim 4, wherein the data path identifier identifies a location of the item of data on a computer of a recipient of the encrypted digital information.

6. The method of claim 4, wherein the data path identifier identifies a location of a plurality of items of data on a computer of a recipient of the encrypted digital information.

7. The method of claim 4, wherein the data path identifier is encrypted using a public key encryption scheme.

8. The method of claim 4, wherein the data path identifier and the encrypted digital information are further encrypted using a public key encryption scheme.

9. The method of claim 1, wherein the key generation algorithm is a key generation algorithm that is selected from a plurality of key generation algorithms that have previously been provided to a recipient of the encrypted digital information.

10. The method of claim 1, further comprising:
subsequent to encrypting the digital information, destroying the dynamic key.

11. The method of claim 27, wherein only a portion of the item of data is used in conjunction with the key generation algorithm to generate a dynamic key.

12. A method for updating a dynamic encryption key generation system, the method comprising:
identifying a client for which an update is to be performed;
determining whether a library is to be updated, wherein the library includes an item of data usable for generating a dynamic key; and
in response to determining that the library is to be updated, providing an update to the library.

13. The method of claim 12, further comprising:
determining whether a first dynamic key generation algorithm is to be updated; and
in response to determining that the first dynamic key generation algorithm is to be updated, providing a second dynamic key generation algorithm.

14. The method of claim 13, wherein the second dynamic key generation algorithm replaces the first dynamic key generation algorithm.

15. The method of claim 13, wherein the first dynamic key generation algorithm is one of a plurality of dynamic key generation algorithms provided to the client for generating a dynamic encryption key.

16. The method of claim 12, wherein the library is provided to a client by a host, and wherein the library includes a plurality of items of data.

17. The method of claim 16, wherein one of the plurality of items of data may be used with a dynamic key generation algorithm to generate the dynamic key.

18. The method of claim 12, wherein the item of data is a file.

19. A dynamic key generation system comprising:
a library, including an item of data; and
at least one dynamic key generation algorithm for use in conjunction with the item of data for computing a dynamic key.

20. The dynamic key generation system of claim 19, wherein the item of data is any type of digital file.

21. The dynamic key generation system of claim 19, wherein the library is provided to a client from a host.

22. The dynamic key generation system of claim 19, wherein the item of data from the library is know to both a host and a client.

23. The dynamic key generation system of claim 19, wherein the at least one dynamic key generation algorithm is known to both a host and a client.

24. The dynamic key generation system of claim 19, wherein the dynamic key is utilized to encrypt a digital message that is to be transmitted from a host to a client.

25. The dynamic key generation system of claim 24, wherein the dynamic key is destroyed subsequent to encryption of the digital message.

26. The dynamic key generation system of claim 19, wherein the dynamic key is utilized in conjunction with a decryption algorithm to decrypt an encrypted digital message that is received by a client from a host.

27. The dynamic key generation system of claim 26, wherein the dynamic key is destroyed subsequent to decryption of the digital message.

28. A method for dynamically decrypting digital information, the method comprising:
obtaining encrypted digital information;
identifying a item of data;
executing a key generation algorithm in conjunction with the identified item of data to generate a dynamic key; and
decrypting the encrypted digital information using the dynamic key and a decryption algorithm.

29. The method of claim 28, wherein the key generation algorithm is selected from a plurality of key generation algorithms.

30. The method of claim 28, wherein the item of data is a file and the file is selected from a plurality of files.

31. The method of claim 28, further comprising:
obtaining a data path identifier from the encrypted digital information that identifies a location of the item of data.

32. The method of claim 31, wherein the data path identifier identifies a location of the item of data on a computer of a recipient of the encrypted digital information.

33. The method of claim 31, wherein the data path identifier identifies a location of a plurality of items of data on a computer of a recipient of the encrypted digital information.

34. The method of claim 31, wherein the data path identifier is encrypted using a public key encryption scheme.

35. The method of claim 31, wherein the data path identifier and the encrypted digital information are further encrypted using a public key encryption scheme.

36. The method of claim 28, wherein the key generation algorithm is a key generation algorithm that is selected from a plurality of key generation algorithms that have previously been provided to a recipient of the encrypted digital information.

37. The method of claim 28, further comprising:
subsequent to encrypting the digital information, destroying the dynamic key.

38. The method of claim 28, wherein only a portion of the item of data is used in conjunction with the key generation algorithm to generate a dynamic key.
